(19) United States
(12) Patent Application Publication
(10) Pub. No.: US 2007/0153388 A1
(43) Pub. Date: Jul. 5, 2007

(54) Apparatus and method for controlling optical output of mobile display using diffractive light modulator

(75) Inventor: Kyu Bum Han, Yongin-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd., Suwon-si (KR)

(21) Appl. No.: 11/642,319

(22) Filed: Dec. 19, 2006

(30) Foreign Application Priority Data
Jan. 4, 2006 (KR) 10-2006-0000966

(51) Int. Cl. G02B 5/18

(52) U.S. Cl. 359/572; 359/108

(57) ABSTRACT

Disclosed herein is an apparatus and method for controlling the optical output of a mobile display using a single-panel type diffractive light modulator. The apparatus includes a surrounding light amount information storage unit and an optical output adjusting means. The surrounding light amount information storage unit stores information about the amount of surrounding light. The optical output adjusting means adjusts the output values of red, green and blue light sources based on the information about the amount of surrounding light.

### CROSS REFERENCE TO RELATED APPLICATION

This application claims the benefit of Korean Patent Application No. 10-2006-0000966, filed on Jan. 4, 2006, entitled “Apparatus and Method of Controlling Optical Power for Mobile Display using Diffraction Modulation”, which is hereby incorporated by reference in its entirety into this application.

### BACKGROUND OF THE INVENTION

1. Field of the Invention

The present invention relates generally to an apparatus and method for controlling the optical output of a mobile display using a diffractive light modulator and, more particularly, to an apparatus and method for controlling the optical output of a mobile display using a diffractive light modulator, which adjusts the output values of light sources based on the amount of surrounding light or on a user's selection, thereby reducing power consumption during the use of the display.

2. Description of the Related Art

Recently, micromachining technology for manufacturing micro-optical parts, such as micromirrors, micro-lenses and micro-switches, micro-inertial sensors, micro-biochips and micro-Radio Frequency (RF) communication elements using a semiconductor device manufacturing process has been developed.

Such micromirrors are used in various ways, both statically and dynamically moving in vertical, diagonal and horizontal directions. With respect to movement in a vertical direction, micromirrors are used as phase correctors and diffraction devices, with respect to movement in an diagonal direction, micromirrors are used as scanners, switches, optical signal distributors, optical signals attenuators and light source arrays, and, with respect to movement in a horizontal direction, micromirrors are used as optical shielding devices, optical switches and optical signal distributors.

An example of such micromirrors is a reflective deformable grating light modulator 10, which is illustrated in FIG. 1. The light modulator 10 is disclosed in U.S. Pat. No. 5,311,360, issued to Broom et al. The light modulator 10 includes a reflecting surface 22, and a plurality of deformable reflective ribbons 18, which are suspended over a silicon substrate 16 and are regularly spaced apart from each other. An insulating layer 11 is deposited on the silicon substrate 16. Thereafter, a sacrificial silicon dioxide film 12 and a silicon nitride film 14 are deposited thereon.

The silicon nitride layer 14 is patterned using the ribbons 18, and part of the silicon dioxide layer 12 is etched, so that the ribbons 18 are held over an oxide spacer layer by a nitride frame 20.

To modulate light having a single wavelength of λ₀, the light modulator 10 is designed such that the thickness of the ribbons 18 and the thickness of the oxide spacer 12 are λ₀/4 each.

The amplitude of vibration of the grating of the light modulator 10, which is limited to the vertical distance d between the reflective surface 22 of the ribbons 18 and the reflective surface 22 of the substrate 16, is controlled by applying voltage between the ribbons 18 (the reflective surface 22 of the ribbons 18 that functions as a first electrode) and the substrate 16 (a conductive layer 24 that is located below the substrate 16 and functions as a second electrode).

The above-described light modulator has a variety of potential applications, and an important consideration in the applications is reduced power consumption.

### SUMMARY OF THE INVENTION

The present invention provides an apparatus and method for controlling the optical output of a mobile display using a diffractive light modulator, which adjusts the output values of light sources based on the amount of surrounding light or on a user's selection, thereby reducing power consumption during the use of the display.

In order to accomplish the above object, the present invention provides an apparatus for controlling the optical output of a mobile display using a single-panel type diffractive light modulator, including a surrounding light amount information storage unit for storing information about the amount of surrounding light; and an optical output adjusting means for adjusting the output values of red, green and blue light sources based on the information about the amount of surrounding light.

In order to accomplish the above object, the present provides an apparatus for controlling the optical output of a mobile display using a single-panel type diffractive light modulator, including a power saving mode selecting unit for selecting any one piece of power saving mode information from among pieces of power saving mode information supplied from a user; and an optical output adjusting means for adjusting the output values of red, green and blue light sources based on the power saving mode information supplied from the power saving mode selecting unit.

In order to accomplish the above object, the present provides a method of controlling the optical output of a mobile display using a single-panel type diffractive light modulator, including a first step of storing information about the amount of surrounding light; and a second step of adjusting the output values of red, green and blue light sources based on the information about the amount of surrounding light.

In order to accomplish the above object, the present provides a method of controlling the optical output of a mobile display using a single-panel type diffractive light modulator, including a first step of selecting any one piece of power saving mode information from among pieces of power saving mode information supplied from a user; and a second step of adjusting the output values of red, green and blue light sources based on the selected power saving mode information.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the construction of a conventional reflective deformable grating light modulator;

FIG. 2 is a sectional view of a recess-type thin film piezoelectric light modulator;

FIG. 3 is a block diagram of a display system using a single panel-type diffractive light modulator, which is applied to a mobile terminal equipped with an optical output control apparatus according to the present disclosure;

FIG. 4 is a block diagram illustrating the projection control unit of FIG. 3;

FIG. 5 is a block diagram illustrating the internal construction of an optical output control apparatus according to the present disclosure;

FIG. 6 is a flowchart illustrating an optical output control method according to the present disclosure;

FIG. 7 is a graph illustrating the optimal brightness characteristics of a mobile display;

FIG. 8 is a block diagram illustrating the internal construction of an optical output control apparatus according to another example of the present disclosure; and

FIG. 9 is a flowchart illustrating an optical output control method according to another example of the present disclosure.

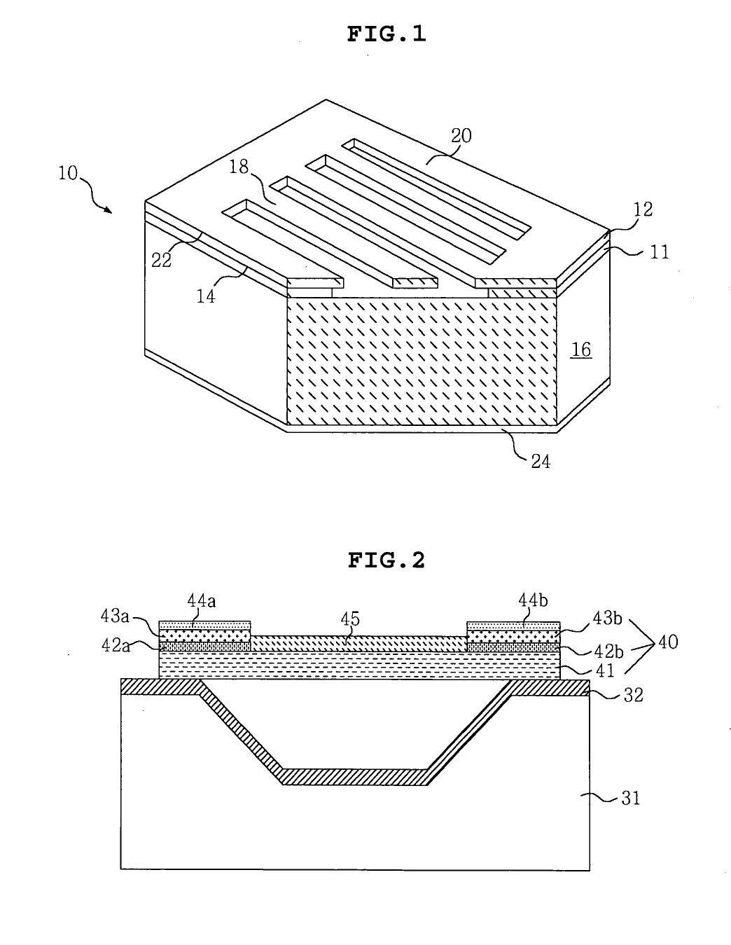

### DESCRIPTION OF THE PREFERRED EMBODIMENTS

Reference now should be made to the drawings, in which the same reference numerals are used throughout the different drawings to designate the same or similar components.

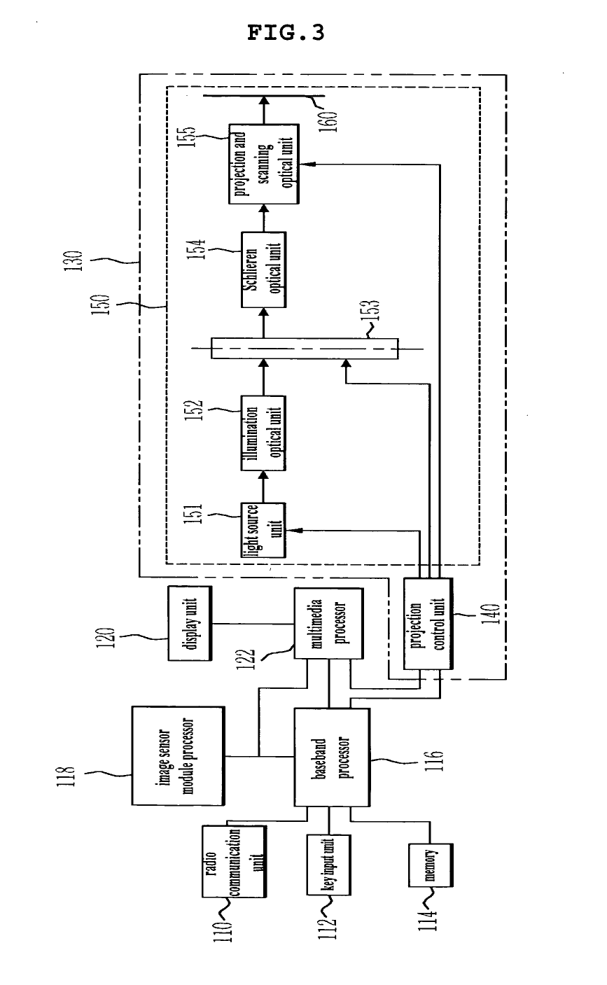

FIG. 2 is a sectional view of a recess-type thin film piezoelectric light modulator.

Referring to FIG. 2, the recess-type thin film piezoelectric light modulator includes a silicon substrate 31 and a plurality of elements 40.

The elements 40 may have a uniform width and be regularly arranged, thereby constituting the recess-type thin film piezoelectric light modulator. Alternatively, the elements 40 may have different widths and be alternately arranged, thereby constituting the recess-type thin film piezoelectric light modulator. Furthermore, the elements 40 are spaced apart from each other at regular intervals (each of the intervals is substantially equal to the width of the elements 40), such that a micromirror layer, formed over the entire top surface of the silicon substrate 31, diffracts incident light by reflecting the incident light.

The silicon substrate 31 has a recess so as to provide an air space for the elements 40. An insulating layer 32 is disposed on the upper surface of the silicon substrate 31, and the ends of the elements 40 are attached to the opposite sides of the recess.

Each of the elements 40 has a rod shape. The bottom surfaces of the ends of the element 40 are attached to the opposite sides of the silicon substrate 31 so that the central portion of the element 40 spans the recess of the silicon substrate 31. The element 40 includes a lower support 41, a portion of which, which is located over the recess of the silicon substrate 31, can move vertically.

Furthermore, the element 40 further includes a lower electrode layer 42a that is placed on the left end of the lower support 41 and provides piezoelectric voltage, a piezoelectric material layer 43a that is placed on the lower electrode layer 42a and generates vertical actuation force through expansion and contraction thereof when voltage is applied across both surfaces thereof, and an upper electrode layer 44a that is placed on the piezoelectric material layer 43a and provides piezoelectric voltage to the piezoelectric material layer 43a.

The element 40 further includes a lower electrode layer 42b that is placed on the right end of the lower support 41 and provides piezoelectric voltage, a piezoelectric material layer 43b that is placed on the lower electrode layer 42b and generates vertical actuation force through expansion and contraction thereof when voltage is applied to both surfaces thereof, and an upper electrode layer 44b that is placed on the piezoelectric material layer 43b and provides piezoelectric voltage to the piezoelectric material layer 43b.

FIG. 3 is a block diagram of a display system using a single panel-type diffractive light modulator, which is applied to a mobile terminal equipped with an optical output control apparatus according to an embodiment of the present invention.

Referring to FIG. 3, the display system using a single panel-type diffractive light modulator, which is applied to a mobile terminal equipped with an optical output control apparatus according to an embodiment of the present invention, includes a radio communication unit 110, a key input unit 112, memory 114, a baseband processor 116, an image sensor module processor 118, a display unit 120, and a light modulator projector 130.

The radio communication unit 110 wirelessly communicates with an external system, the key input unit 112 receives information from the outside, and the memory 114 stores data such as image data.

The baseband processor 116 causes an image to be displayed on the display unit 120, or directs the projection control unit 140 of the light modulator projector 130, that is, a display system using a single panel-type diffractive light modulator, to project an image onto a screen 160. The baseband processor 116 may be referred to as a terminal control system.

The image sensor module processor 118 processes an image input from a camera or the like, and sends the processed image data to the baseband processor 116.

The display unit 120 displays the image data, supplied from the baseband processor 116, on a screen.

The light modulator projector 130 produces an image using the single panel-type diffractive light modulator based on the image data input from the baseband processor 116, enlarges the produced image, and then projects the enlarged image onto the screen 160 under the control of the baseband processor 116. The light modulator projector 130 includes a projection control unit 140 and a light modulation optical system 150.

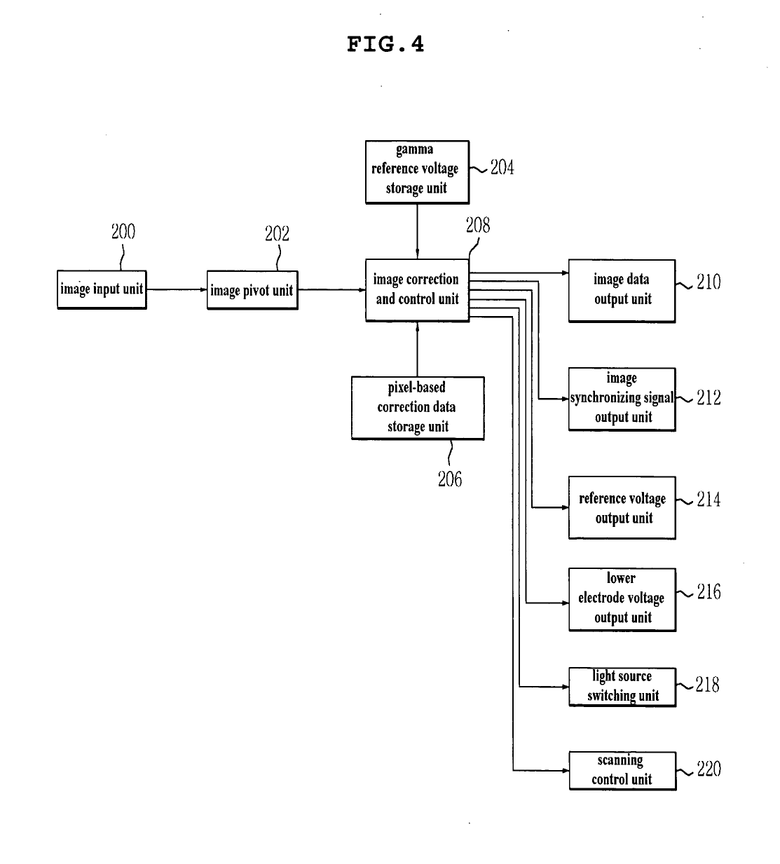

The projection control unit 140 controls the light modulation optical system 150 so that the light modulation optical system 150 produces an image based on the image data, input from the baseband processor 116 according to control signals from the baseband processor 116. The projection control unit 140, as illustrated in FIG. 4, includes an image input unit 200, an image pivot unit 202, a gamma reference voltage storage unit 204, an image correction and control unit 206, a pixel-based correction data storage unit 208, an image data output unit 210, an image synchronizing signal output unit 212, a reference voltage output unit 214, a lower electrode voltage output unit 216, a light source switching unit 218 and a scanning control unit 220. Detailed descriptions thereof will be given later.

The light modulation optical system 150 forms an image, enlarges the produced image and then projects the enlarged image onto the screen 160 according to control signals input from the projection control unit 140. The light modulation optical system 150 includes a light source unit 151, an illumination optical unit 152, a diffractive light modulator 153, a Schlieren optical unit 154, and a projection and scanning optical unit 155.

The light source unit 151 produces and emits red light R, green light G and blue light B according to light source switching control signals supplied from the projection control unit 140, and the illumination optical unit 152 causes light, emitted by the light source unit 151, to be incident on the diffractive light modulator 153.

The diffractive light modulator 153 forms an image by diffracting light incident from the illumination optical unit 152 based on image data signals, reference voltage, lower electrode voltage, a vertical synchronizing signal and a horizontal synchronizing signal supplied from the projection control unit 140 (that is, the illumination optical unit 152 forms diffracted light having a plurality of diffraction orders by diffracting incident light, in which case diffracted light having one or more desired diffraction orders, selected from among a plurality of diffraction orders of the diffracted light, forms the image).

The Schlieren optical unit 154 passes diffracted light having one or more desired diffraction orders, selected from among the plurality of diffraction orders of the diffracted light generated by the diffractive light modulator 153, therethrough.

The projection and scanning optical unit 155 projects an image, formed by diffracted light passed through the Schlieren optical unit 154, onto the screen 160.

FIG. 4 is a block diagram illustrating the projection control unit of FIG. 3.

Referring to FIG. 4, the projection control unit 140 includes the image input unit 200, the image pivot unit 202, the gamma reference voltage storage unit 204, the image correction and control unit 206, the pixel-based correction data storage unit 208, the image data output unit 210, the image synchronizing signal output unit 212, the reference voltage output unit 214, the lower electrode voltage output unit 216, the light source switching unit 218 and the scanning control unit 220. Here, the image input unit 200 and the image pivot unit 202 performs an interface function between the light modulation optical system 150 and a terminal control system.

The image input unit 200 receives image data signals RGB, a vertical synchronizing signal Vsync and a horizontal synchronizing signal Hsync from the baseband processor 116.

The image pivot unit 202 converts image data signals, supplied from the image input unit 200 and arranged in a raster manner (that is, arranged in a lateral direction), into vertically arranged image data signals by performing data transposition on the laterally arranged image data signals, and outputs the resulting signals.

The image pivot unit 202 buffers the vertical synchronizing signal Vsync and the horizontal synchronizing signal Hsync supplied from the image input unit 200. The image pivot unit 202 performs data transposition because the light modulation optical system 150 using the diffractive light modulator 153 scans and displays a plurality of vertically arranged pixels in a lateral direction.

The gamma reference voltage storage unit 204 stores N gamma reference voltages (N is determined based on a gray level) for each of the red, green and blue light sources R, G and B.

The pixel-based correction data storage unit 206 stores the number of pixels (the number of vertical resolutions, that is, the number of mirrors)×n (n varies with the correction method) pieces of pixel-based correction data for each light source. The pieces of pixel-based correction data are stored in a table form.

The image correction and control unit 208 classifies gamma reference voltages, supplied from the gamma reference voltage storage unit 204, for respective light sources, and corrects image data signals, supplied from the image pivot unit 202, based on pixel-based correction data supplied from the pixel-based correction data storage unit 206.

The image correction and control unit 208 sets the target brightness of image data signals, supplied from the image pivot unit 202, based on the amount of surrounding light or a user's selection.

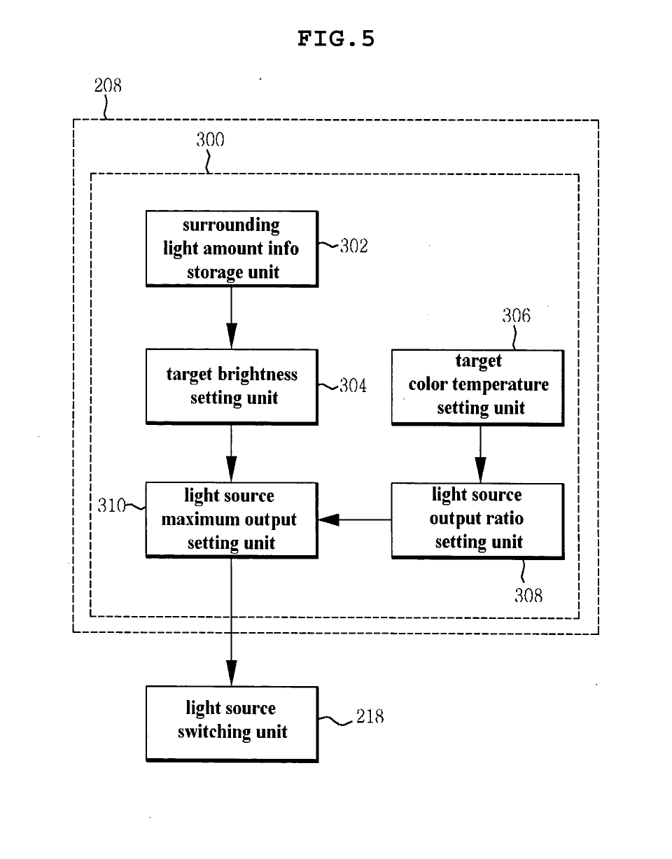

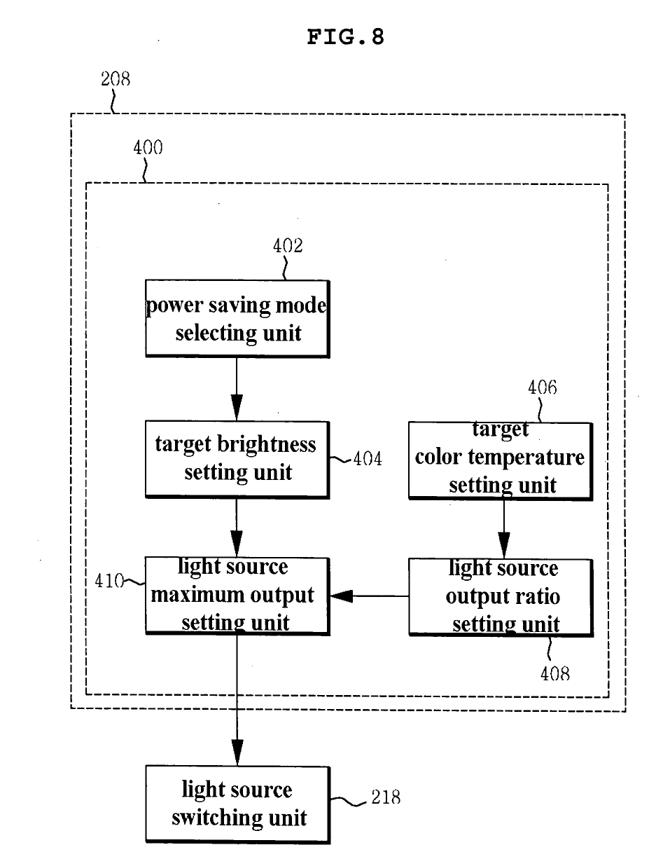

In this case, the image correction and control unit 208 sets the output ratio of light sources based on target color temperatures, sets the maximum output values of the light sources based on the output ratio of the light sources and the target brightness of image data signals, and generates switching control signals based on the set maximum output values. For this purpose, the image correction and control unit 208 is provided with the optical output control apparatus illustrated in FIG. 5 or 8. A detailed description thereof will be given later.

Finally, the image correction and control unit 208 generates scanning control signals using a vertical synchronizing signal and a horizontal synchronizing signal supplied from the image pivot unit 202.

The image data output unit 210 receives image data signals from the image correction and control unit 208 and provides the image data signals to the diffractive light modulator 153, and the image synchronizing signal output unit 212 receives a vertical synchronizing signal and a horizontal synchronizing signal from the image correction and control unit 208 and provides the vertical synchronizing signal and the horizontal synchronizing signal to the diffractive light modulator 153.

The reference voltage output unit 214 receives reference voltage from the image correction and control unit 208 and provides the reference voltage to the diffractive light modulator 153, and the lower electrode voltage output unit 216 receives lower electrode voltage from the image correction and control unit 208 and provides the lower electrode voltage to the diffractive light modulator 153.

The light source switching unit 218 receives light source switching control signals from the image correction and control unit 208 and provides the light source switching control signals to the light source unit 151, and the scanning control unit 220 receives scanning control signals from the image correction and control unit 208 and provides the scanning control signals to the projection and scanning optical unit 155.

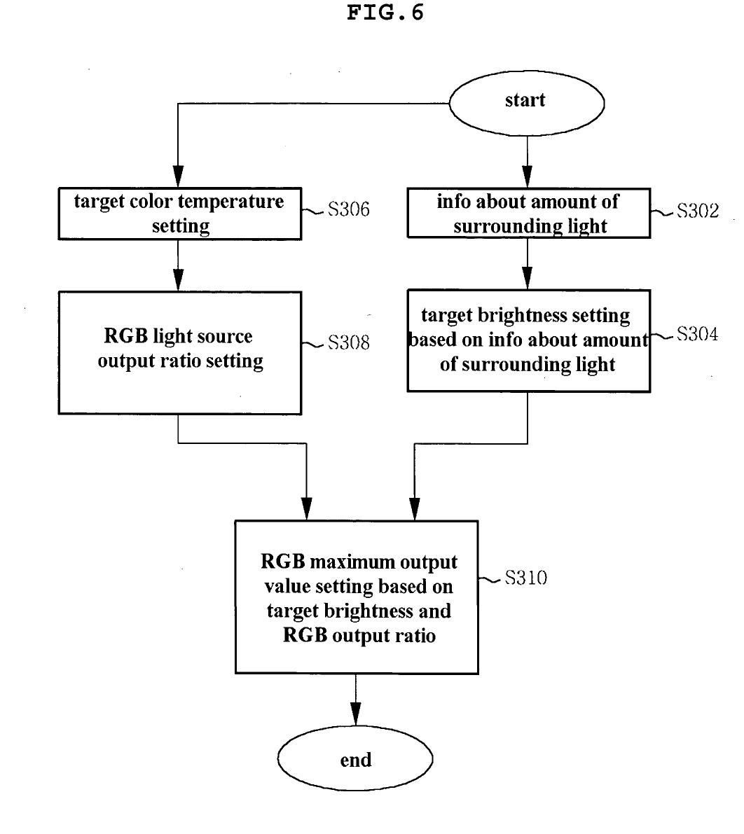

FIG. 5 is a block diagram illustrating the internal construction of an optical output control apparatus according to an embodiment of the present invention, and FIG. 6 is a flowchart illustrating an optical output control method according to an embodiment of the present invention.

Referring to FIGS. 5 and 6, an optical output apparatus 300 according to an embodiment of the present invention includes a surrounding light amount information storage unit 302, a target brightness setting unit 304, a target color temperature setting unit 306, a light source output ratio setting unit 308, and a light source maximum output setting unit 310.

The surrounding light amount information storage unit 302 stores information about the amount of surrounding light based on the display environment conditions, that is, the condition pertaining to the amount of surrounding light, measured using a light amount measurement sensor (not shown), or stores information about the amount of surrounding light based on a user's condition selection (setting based on a level) in a table form. Accordingly, the surrounding light amount information storage unit 302 outputs different surrounding light amount information based on the amount of surrounding light or on a user's selection at step S302.

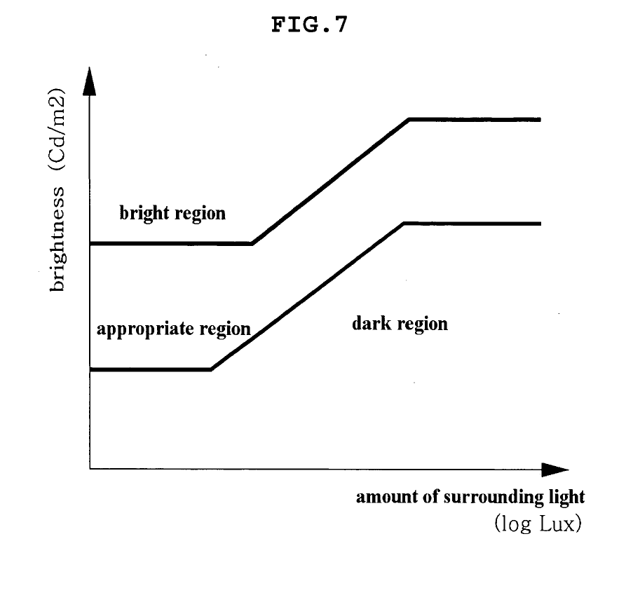

The target brightness setting unit 304 resets target brightness, set by a designer in consideration of target color temperatures (design values) and light source specifications (efficiency, maximum brightness, etc.), to appropriate brightness, that is, optimized target brightness, based on information about the amount of surrounding light supplied from the surrounding light amount information storage unit 302 at step S304. That is, in order to represent appropriate brightness according to the display environment conditions, as illustrated in FIG. 7, the target brightness setting unit 304 increases a set target brightness value if the amount of surrounding light increases, and decreases the set target brightness if the amount of surrounding light decreases. Here, the target brightness setting unit 304 may reset the target brightness value of image data signals based on the empirical data of an image displayed by the display unit 120.

The target color temperature setting unit 306 sets the color temperatures of the red, green and blue light sources to values desired by a user at step S306. Here, color temperature values set by the target color temperature setting unit 306 are constant regardless of the target brightness value.

The light source output ratio setting unit 308 sets the output ratio of the red, green and blue light sources based on the target color temperatures supplied from the target color temperature setting unit 306 at step S308.

The light source maximum output setting unit 310 sets the maximum output values of the red, green and blue light sources based on the set target brightness value supplied from the target brightness setting unit 304 and the light source output ratio value supplied from the light source output ratio setting unit 308 at step S310. The light source maximum output setting unit 310 generates control signals for controlling the switching of the red, green and blue light sources based on the set maximum output values of the light sources. Here, the generated switching control signals are supplied to the light source switching unit 218.

In the optical output control apparatus according to an embodiment of the present invention, the target brightness setting unit 304, the target color temperature setting unit 306, the light source output ratio setting unit 308 and the light source maximum output setting unit 310 are used as an optical output adjusting means that adjusts the output values of the red, green and blue light sources based on the information about the amount of surrounding light supplied from the surrounding light amount information storage unit 302.

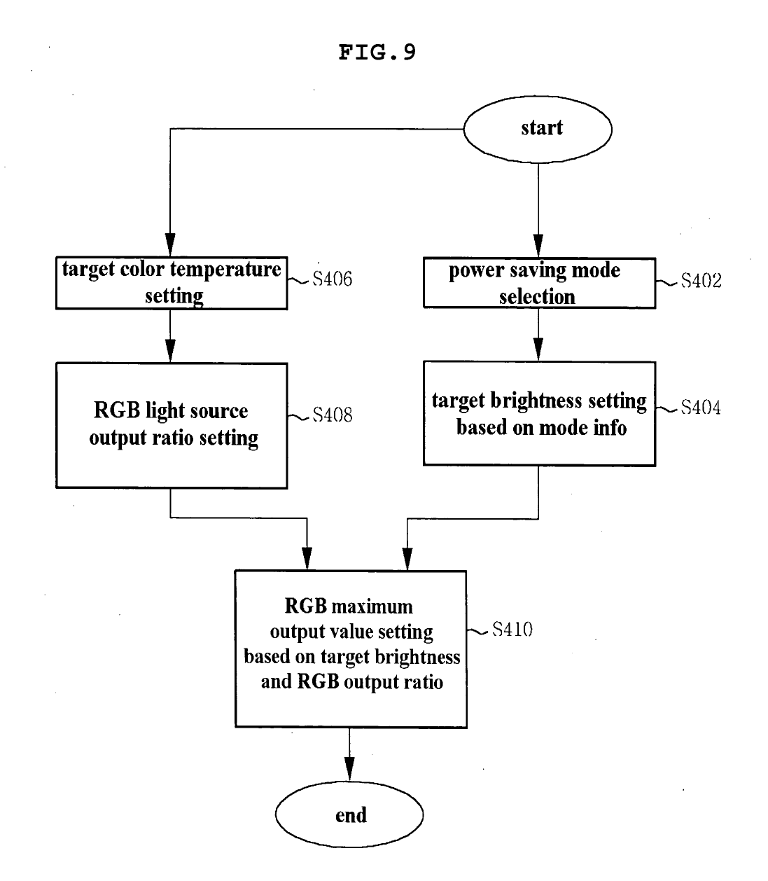

FIG. 8 is a block diagram illustrating the internal construction of an optical output control apparatus according to another embodiment of the present invention. FIG. 9 is a flowchart illustrating an optical output control method according to another embodiment of the present invention.

Referring to FIGS. 8 and 9, the optical output apparatus 400 according to another embodiment of the present invention includes a power saving mode selecting unit 402, a target brightness setting unit 404, a target color temperature setting unit 406, a light source output ratio setting unit 408, and a light source maximum output setting unit 410.

The power saving mode selecting unit 402 selects any one piece of power saving mode information from among pieces of power saving mode information supplied by a user at step S402.

The target brightness setting unit 404 resets target brightness, set by a designer in consideration of target color temperatures (design values) and light source specifications (efficiency, maximum brightness, etc.), to appropriate brightness, that is, optimized target brightness, based on the mode information supplied from the power saving mode setting unit 402 at step S404. That is, the target brightness setting unit 404 sets a target brightness value for 50% of the maximum target brightness if mode information for selecting 50% of the maximum target brightness is supplied from the power saving mode selecting unit 402, and sets a target brightness value for 10% of the maximum target brightness if mode information for selecting 10% of the maximum target brightness. The target brightness setting unit 404 may reset the target brightness value based on the empirical data of an image displayed by the display unit 120.

The target color temperature setting unit 406 sets the color temperatures of the red, green and blue light sources to values desired by a user at step S406. Here, the color temperature values set by the target color temperature setting unit 406 are constant regardless of the target brightness value.

The light source output ratio setting unit 408 sets the output ratio of the red, green and blue light sources based on the target color temperature supplied from the target color temperature setting unit 406 at step S408.

The light source maximum output setting unit 410 sets the maximum output values of the red, green and blue light sources based on the set target brightness value supplied from the target brightness setting unit 404 and the light source output ratio value supplied from the light source output ratio setting unit 408 at step S410. The light source maximum output setting unit 410 generates controls signals for controlling the switching of the red, green and blue light sources based on the set maximum output values of the light sources. Here, the generated switching control signals are supplied to the light source switching unit 218.

In the above-described optical output control apparatus according to another embodiment of the present invention, the target brightness setting unit 404, the target color temperature setting unit 406, the light source output ratio setting unit 408 and the light source maximum output setting unit 410 are used as an optical output adjusting means that adjusts the output values of the red, green and blue light sources based on the power saving mode information supplied from the power saving mode selecting unit 402.

As described above, the present invention resets the target brightness of image data signals based on the amount of surrounding light and adjusts light source output values based on the reset target brightness and the output ratio of the red, green and blue light sources, thereby reducing the power consumption of the light sources during the use of a display system.

Furthermore, when a user selects a power saving mode, the present invention adjusts light source output values based on target brightness in the selected power saving mode and the output ratio of the red, green and blue light sources, thereby reducing the power consumption of the light sources during the use of a display system.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for controlling optical output of a mobile display using a single-panel type diffractive light modulator, comprising:
a surrounding light amount information storage unit for storing information about an amount of surrounding light; and
optical output adjusting means for adjusting output values of red, green and blue light sources based on the information about the amount of surrounding light.

2. The apparatus as set forth in claim 1, wherein the surrounding light amount information storage unit stores information about the amount of surrounding light measured using a light amount measurement sensor.

3. The apparatus as set forth in claim 1, wherein the surrounding light amount information storage unit stores information about the amount of surrounding light based on a user's selection in a table form.

4. The apparatus as set forth in claim 1, wherein the optical output adjusting means comprises:
a target brightness setting unit for resetting a target brightness value based on the amount of surrounding light supplied from the surrounding light amount information storage unit;
a target color temperature setting unit for setting target color temperatures of red, green and blue light sources;
a light source output ratio setting unit for setting an output ratio of the red, green and blue light sources based on the set target color temperatures supplied from the target color temperature setting unit; and
a light source maximum output setting unit for setting maximum output values of the red, green and blue light sources based on the target brightness value supplied from the target brightness setting unit and the light source output ratio supplied from the light source output ratio setting unit, and generating switching control signals for the light sources based on the set output values.

5. The apparatus as set forth in claim 4, wherein the target brightness setting unit increases the set target brightness value if the amount of surrounding light increases, and decreases the set target brightness value if the amount of surrounding light decreases.

6. The apparatus as set forth in claim 4, wherein the target brightness setting unit resets the target brightness value of image data signals based on empirical data.

7. An apparatus for controlling optical output of a mobile display using a single-panel type diffractive light modulator, comprising:
a power saving mode selecting unit for selecting any one piece of power saving mode information from among pieces of power saving mode information supplied from a user; and
optical output adjusting means for adjusting output values of red, green and blue light sources based on the power saving mode information supplied from the power saving mode selecting unit.

8. The apparatus as set forth in claim 7, wherein the optical output adjusting means comprises:
a target brightness setting unit for resetting a target brightness value based on the power saving mode information supplied from the power saving mode selecting unit;
a target color temperature setting unit for setting target color temperatures of the red, green and blue light sources;
a light source output ratio setting unit for setting an output ratio of the red, green and blue light sources based on the set target color temperatures supplied from the target color temperature setting unit; and
a light source maximum output setting unit for setting maximum output values of the red, green and blue light sources based on the target brightness value supplied from the target brightness setting unit and the light source output ratio supplied from the light source output ratio setting unit, and generating switching control signals for the light sources based on the set output values.

9. A method of controlling optical output of a mobile display using a single-panel type diffractive light modulator, comprising:
storing information about an amount of surrounding light; and
adjusting output values of red, green and blue light sources based on the information about the amount of surrounding light.

10. The method as set forth in claim 9, wherein the step of storing information comprises:
resetting a target brightness value based on the amount of surrounding light;
setting target color temperatures of red, green and blue light sources;
setting an output ratio of the red, green and blue light sources based on the set target color temperatures; and
setting maximum output values of the red, green and blue light sources based on the set target brightness value and the light source output ratio, and generating switching control signals for the light sources based on the set output values.

11. A method of controlling optical output of a mobile display using a single-panel type diffractive light modulator, comprising:
selecting any one piece of power saving mode information from among pieces of power saving mode information supplied from a user; and
adjusting output values of red, green and blue light sources based on the selected power saving mode information.

12. The method as set forth in claim 11, wherein the second step comprises steps of:
resetting a target brightness value based on the power saving mode information;
setting target color temperatures of the red, green and blue light sources;
setting an output ratio of the red, green and blue light sources based on the set target color temperatures; and
setting maximum output values of the red, green and blue light sources based on the set target brightness value and the light source output ratio, and generating switching control signals for the light sources based on the set output values.
